(19) United States
(12) Patent Application Publication
(10) Pub. No.: US 2008/0143478 A1
(43) Pub. Date: Jun. 19, 2008

(54) Mobile unit and electronic key system using the same

(75) Inventors: Masahiro Sugiura, Takahama-city (JP); Hiromichi Naitoh, Okazaki-city (JP); Munenori Matsumoto, Kariya-city (JP); Noriaki Okada, Chiryu-city (JP); Shinichirou Katou, Kariya-city (JP); Gorou Inoue, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/000,786

(22) Filed: Dec. 17, 2007

(30) Foreign Application Priority Data
Dec. 19, 2006 (JP) 2006-341211

(51) Int. Cl. G06F 7/04

(52) U.S. Cl. 340/5.61; 340/5.7

(57) ABSTRACT

A mobile unit for an electronic key system includes an LF receiver unit that receives a radio signal transmitted from an in-vehicle device by an electric wave of an LF band, a UHF transmitter unit that transmits a radio signal to the in-vehicle unit by an electric wave of a UHF band. The mobile unit also includes a UHF receiver unit that receives a search signal transmitted from another mobile unit by an electric wave of the UHF band, and a buzzer that notifies outside existence thereof when the search signal is received by the UHF receiver unit. The UHF transmitter unit can transmit the search signal to the mobile unit in addition to the radio signal to the in-vehicle device.

### CROSS REFERENCE TO RELATED APPLICATION

This application is based on and incorporates herein by reference Japanese Patent Application No. 2006-341211 filed on Dec. 19, 2006.

### FIELD OF THE INVENTION

The present invention relates to a mobile unit and an electronic key system using the same.

### BACKGROUND OF THE INVENTION

In the field of a vehicle-related technology, an electronic key system is made up of an in-vehicle device that is mounted in a vehicle, and a mobile unit that is carried by a user of a vehicle. This electronic key system is so configured as to execute the control of the lock/unlock of doors or engine starting when authentication is approved via a radio communication between the in-vehicle device and the mobile unit even if a mechanical key of the vehicle is not operated.

Also, when the mobile unit of the electronic key system is lost, it is not easy to locate or find the mobile unit. Therefore, a mobile unit locating device, which is used when the user wants to locate the mobile unit, has been already proposed (for example, JP 2005-220728A).

However, the above mobile unit locating device is not routinely operated, but is operated only under the condition where the mobile unit is lost. For this reason, it is likely that a user, who has too much confidence in his appropriate management that he does not usually lose the mobile unit, does not introduce the mobile unit locating device. Therefore, such a user does not know how to deal with the lost mobile unit.

Also, in the conventional electronic key system, different frequency bands are used between the signal transmission from the in-vehicle device to the mobile unit and the signal transmission from the mobile unit to the in-vehicle device. More specifically, in many cases, a communication at the LF (low frequency) is conducted at the time of transmitting a signal from the in-vehicle device to the mobile unit, and a communication at the UHF (ultra high frequency) is conducted at the time of transmitting a signal from the mobile unit to the in-vehicle device.

A main purpose of using the LF band at the time of transmitting the signal from the in-vehicle device to the mobile unit is to limit the detection area of the mobile unit to the periphery of the vehicle, and a main purpose of using the UHF band at the time of transmitting the signal from the mobile unit to the in-vehicle device is to obtain a relatively long communication distance even at a weak output level.

However, in the case of locating the lost mobile unit, a search signal that is transmitted from the mobile unit locating device to the mobile unit must be transmitted at the LF band that can be received by the mobile unit side. For that reason, when the communication due to the inductive coupling at the LF band is conducted, the detection area of the mobile unit is limited to the periphery of the mobile unit locating device as in the case of the in-mobile unit. When the mobile unit is out of the detection area, the mobile unit cannot be easily found.

Also, when the detection area of the mobile unit is enlarged, there is proposed a method in which the output level of the mobile unit locating device is enhanced. However, in the existing structure that conducts a communication at the above-mentioned LF band, an enlargement of the detection area is limited even if the output level of the mobile unit locating device is enhanced. This is because even if the output level is considerably increased, the communication distance is not comparatively extended.

### SUMMARY OF THE INVENTION

The present invention has therefore has an object to provide a mobile unit and an electronic key system which is capable of locating the mobile unit even if an exclusive device for the mobile unit search is not used, and an electronic key system having the mobile unit.

According to one aspect of the present invention, a mobile unit is provided for an electronic key system that includes an in-vehicle device for executing predetermined control. The mobile unit receives a radio signal that is transmitted from the in-vehicle device by an electric wave of a first frequency band, and transmits a radio signal to the in-vehicle device by an electric wave of a second frequency band which is different from the first frequency band thereby to enable the in-vehicle device to conduct authentication required to execute the predetermined control. The mobile unit further receives a radio signal including at least a search signal which is transmitted from another mobile unit by an electric wave of the second frequency band. The mobile unit further notifies outside existence thereof, when receiving the search signal. The mobile unit is configured to be capable of transmitting the search signal in addition to the radio signal to the in-vehicle device.

According to another aspect of the present invention, an electronic key system is provided for controlling a door of an object, and has an in-object device and a plurality of mobile units. The in-object device is provided in the object and having a receiving section for controlling the door in response to a predetermined signal of a predetermined frequency band received by the receiving section. The plurality of mobile units each has a transmitter for transmitting the predetermined signal of the predetermined frequency band to be received by the in-object device. The transmitter is configured to transmit a search signal including an identification of a mobile unit, which is to be located. The search signal is of the predetermined frequency band. The mobile unit has a receiver for receiving a search signal of the predetermined frequency band, and a notifying section for generating a notification indicative of existence in response to a reception of the search signal by the receiver.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an electronic key system according to an embodiment of the present invention;

FIG. 2 is a flowchart showing a search process according to a first embodiment;

FIG. 3 is a flowchart showing a post-search process according to the first embodiment;

FIG. 4 is a flowchart showing a search process according to a second embodiment;

FIG. 5 is a flowchart showing a search process according to a third embodiment;

FIG. 6 is a block diagram showing a simplified mobile unit having only located function; and

FIG. 7 is a block diagram showing a locating unit having only a search function and a mobile phone.

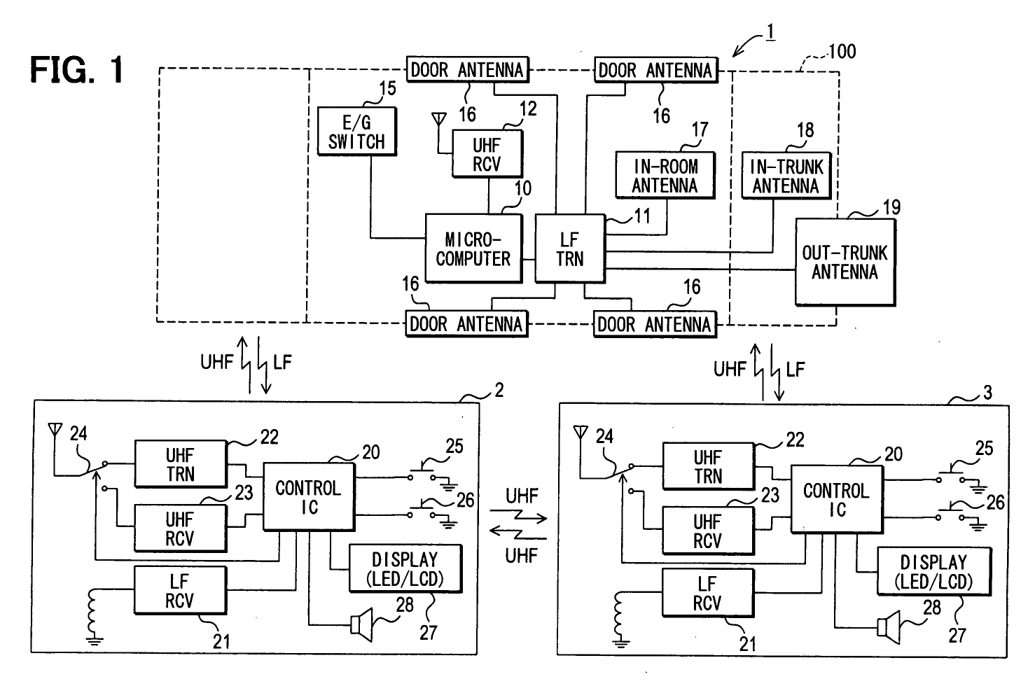

### DETAILED DESCRIPTION OF THE PREFERRED EMBODIMENTS

### First Embodiment

An electronic key system described below has a smart entry function of executing the control of unlocking of doors when a specific mobile unit that is carried by a regular user of a vehicle enters the radio communication area around the vehicle, and a keyless entry function of executing the control of unlocking of the doors according to the button function of the mobile unit.

The electronic key system includes an in-vehicle device 1 that is mounted in a vehicle 100, and plural mobile units 2 and 3.

The in-vehicle device 1 includes a microcomputer 10, an LF transmitter unit 11, a UHF receiver unit 12, an engine switch 15, a door antenna 16 attached to a vehicle door, an in-room antenna 17 provided in a passenger compartment, an in-trunk antenna 18 provided in a luggage trunk, and an out-trunk antenna 19 provided outside the luggage trunk.

The LF transmitter unit 11 is for transmitting a radio signal to the mobile units 2 and 3. The radio signal that is transmitted from the LF transmitter unit 11 reaches the respectively limited communication areas through the door antenna 16, the in-room antenna 17, the in-trunk antenna 18, and the out-trunk antenna 19. The UHF receiver unit 12 is for receiving the radio signals that are transmitted from the mobile units 2 and 3.

The engine switch 15 is operable by a vehicle user when an engine starts. When an operation of the engine switch 15 by the user is detected by a signal from the engine switch 15, the microcomputer 10 checks whether engine starting is enabled or not. When the engine starting is enabled, an engine start signal is transmitted from the microcomputer 10 to an engine control system.

Also, each of the mobile units 2 and 3 has a control IC 20, an LF receiver unit 21, a UHF transmitter unit 22, a UHF receiver unit 23, a transmit/receive changeover switch 24, push switches 25, 26, a display unit 27, and a buzzer 28.

The LF receiver unit 21 is for receiving the radio signal that is transmitted from the in-vehicle device 1, and the UHF transmitter unit 22 is for transmitting the radio signal to the in-vehicle device 1. Also, the UHF transmitter unit 22 is for transmitting the radio signal when the mobile units 2 and 3 communicate with each other, and the UHF receiver unit 23 is for receiving the radio signal when the mobile units 2 and 3 communicate with each other.

The transmit/receive changeover switch 24 is subjected to changeover control by the control IC 20. The transmit/receive changeover switch 24 changes over whether the transmission is conducted by the UHF transmitter unit 22, or the reception is conducted by the UHF receiver unit 23. This embodiment is applied to a configuration in which the receive changeover switch 24 changes over transmission or reception to conduct half-duplex communication. However, other configurations can be applied when transmission and reception can be implemented. For example, a circulator is applied instead of the transmit/receive changeover switch 24, to thereby conduct transmission and reception with full duplex communication.

The push switches 25 and 26 are prepared as keys that are triggers for mainly using a remote keyless entry function. In the case of conducting one-push operation, the push switch 25 is for instructing locks of the doors whereas the push switch 26 is for instructing unlocks of the doors. In this embodiment, when operation other than one-push operation is conducted, the push switches 25 and 26 are used as a key that is a trigger for transmitting a search signal, or a key for conducting the operation of selecting one locating unit from plural locating units.

The display unit 27 is made up of LCD or LED. When the mobile units 2 and 3 are used as the locating units or search units, a list of the located unit is displayed on the LCD, and a desired located unit is selected by the user. Also, when a communication is realized between the mobile units 2 and 3, the LED is blinked. The LED functions as notifying means for notifying the presence of the locating unit at the retried device side, and functions as display means for displaying the fact that there is a response from the located device.

The buzzer 28 functions as notifying means for notifying the presence of the search device. That is, in this embodiment, both of the display unit 27 (LED) and the buzzer 28 are applied as the notifying means.

The electronic key system performs the smart entry function as follows.

The respective portions of the in-vehicle device 1 are operated while being controlled by the microcomputer 10, and the LF transmitter unit 11 periodically transmits a transmission request signal under the control of the microcomputer 10. Also, the respective portions of the mobile unit 2 or 3 are operated while being controlled by the control IC 20. When the mobile unit 2 or 3 enters a radio communication area that can receive the transmission request signal from the LF transmitter unit 11, the receiver unit 21 receives the transmission request signal.

A signal transmission using the electric waves of the LF band is conducted between the LF transmitter unit 11 and the LF receiver unit 21. This is because the detection area of the mobile unit 2 or 3 is limited to the periphery of the vehicle. In particular, the signals are transmitted from the door antennas 16, the in-room antenna 17, the in-trunk antenna 18, and the out-trunk antenna 19, the detection area can be limited to the vicinity of the doors, inside the compartment, inside the luggage trunk, and outside the luggage trunk. As a result, it is possible to detect where the mobile unit 2 or 3 exists, and to prevent the mobile unit 2 or 3 being locked in, for example, when the mobile unit 2 or 3 is left in the passenger compartment or luggage trunk.

When the LF receiver unit 21 receives the transmission request signal from the in-vehicle device 1, the transmit/receive changeover switch 24 is changed over to the transmitter side, and the UHF transmitter unit 22 transmits a response signal including codes specific to vehicle corresponding to the mobile unit 2 or 3. Then, in the in-vehicle device 1, the UHF receiver unit 12 receives the response signal from the mobile units 2 or 3.

A signal transmission using the electric waves of the UHF band is conducted between the UHF transmitter unit 22 and the UHF receiver unit 12. This is because a deserved communication distance is ensured even if the output power level of the mobile unit 2 or 3 is relatively low, and the response signal can be more surely transmitted to the in-vehicle device 1.

When the UHF receiver unit 12 receives the response signal from the mobile unit 2 or 3, the microcomputer 10 in the in-vehicle device 1 checks whether the code included in the response signal coincides with the code that is stored in the microcomputer 10 or not for authentication. When the former coincides with the latter, the unlocking of the doors is enabled.

In the subsequent process, a known control in the electronic key system of this type is executed. For example, when a user's touch on a door knob is detected according to a signal from a touch sensor (Not shown) which is disposed in the door knob outside of a driver's door in an unlocking enable state, the microcomputer 10 transmits the unlock signal to a door control system. As a result, a door lock motor (Not shown) is driven so that the all of the doors are unlocked. Also, diverse controls are conducted such that the engine starting is enabled in the known manner.

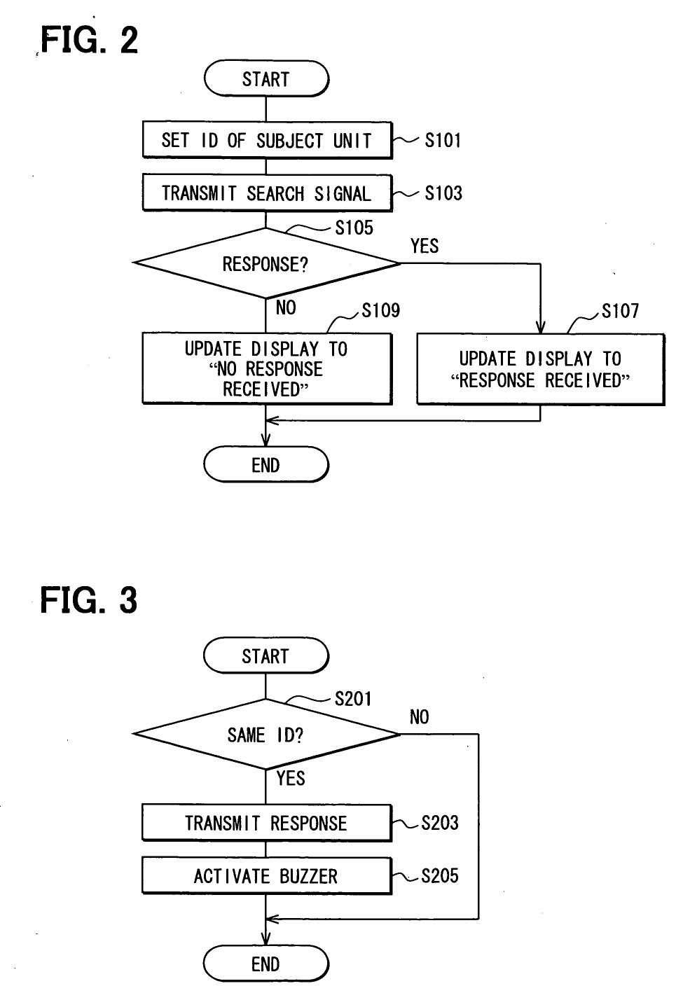

The mobile unit 2 or 3 performs the locating function as shown in FIGS. 2 and 3. It is assumed that the auxiliary mobile unit 3 locates the mobile unit 2 when the mobile unit 2 is lost. The mobile unit 2 is referred to as a subject mobile unit, which is a subject to be located, and the mobile unit 3 is referred to as an auxiliary mobile unit 3. As described above, in this embodiment, since the configurations of the mobile units 2 and 3 are identical with each other, the same processing can be executed even if the mobile unit 2 locates the mobile unit 3.

The auxiliary mobile unit 3 which is at the locating side operates as shown in FIG. 2. The locating process is executed with the operation of the push switches 25 and 26 in a given procedure by the user as a trigger.

When the locating process starts, the auxiliary mobile unit 3 sets an ID to be located (S101). In the process of S101, for example, when the user operates the push switches 25 and 26 in a given procedure, the operation mode of the auxiliary mobile unit 3 is changed over to a subject ID setting mode. When the operation mode is changed over to the subject ID setting mode, the auxiliary mobile unit 3 displays a list of the mobile units that can be selected as a subject mobile unit to be located on the display unit 27.

Now, when the user operates the push switches 25 and 26, and selects one mobile unit from the list, the ID to be located corresponding to the selected mobile unit is set. The list displayed on the display unit can be displayed by serial numbers starting from 1, or with a name (character string) which is understood by the user of the mobile unit which has been registered in advance.

When only one mobile unit that can be selected as a subject unit to be located exists, a structure can be applied in which no display is conducted on the display unit 27, and no selection is conducted by the user. In this case, the ID of the subject unit to be located corresponding to only one mobile unit that can be selected needs to be set without changing to the ID set mode.

Subsequently, the auxiliary mobile unit 3 transmits the search signal including the search ID that has been set in the process of S101 (S103). In the process of S103, the search signal is transmitted through the UHF transmitter unit 22.

Then, the auxiliary mobile unit 3 checks whether there is a response from the subject mobile unit 2 or not (S105). When there is the response (Yes in S105), the display state of the display unit 27 is updated to “response received” (S107), and the locating process is completed. Also, when there is no response (No in S105), the display state of the display unit 27 is updated to “no response received” (S109), and the locating process is completed.

In the process of S103 to S105, it is unnecessary to check whether there is the response or not by only one search signal transmission. For example, it is possible to repeat the search signal when no response is received by one search signal transmission. When no response is received even if a predetermined number of search signal transmissions are repeated, a negative determination is made in the process of S105.

Also, after the transmission of the search signal, waiting is conducted until a response is received even if no response is received until a given period of time is elapsed. Then, when no response is received at a time when the given period of time has been elapsed, it is determined that no response has been received. The process is applied to a case where the transmission and determination of the search signal are repeated a given number of times.

Also, the display states of “response received” and “no response received” in the processes of S107 and S109 can be applied to any style of display states when those display states can be distinguished from each other. As one example, “response received” may be indicated by LED lighting, “no response received” may be indicated by “LED blink.” Alternatively, “response received” may be indicated by LED blink, and “no response received” may be indicated by “LED extinction.” Also, when display is made by the LCD, the character string of “response received” or “no response received” can be displayed on the LCD as it is, and symbols or icons indicative of the respective states can be displayed.

When the above locating process is executed by the auxiliary mobile unit 3, and the transmitted search signal that has been transmitted in the process of S103 reaches the subject mobile unit 2, the located process shown in FIG. 3 is executed in the subject mobile unit 2 with the reception of the search signal as a trigger.

That is, the subject mobile unit 2 first checks whether the ID included in the received search signal is the same as the ID of the mobile unit which has been registered in a nonvolatile memory of the control IC 20 or not (S201).

In the process of S201, when those IDs are not the same (No in S201), the subject mobile unit 2 can determine that the mobile unit 2 is not a subject unit to be located. The subject mobile unit 2 completes this process as it is. On the other hand, in the process of S201, when those IDs coincide with each other (Yes in S201), the subject mobile unit 2 transmits a response to the auxiliary mobile unit 3 (S203), activate the buzzer 28 into a blowing state (S205), and completes the process.

In the process of S205, when the buzzer 28 is excessively blown for a long period of time, an electric power will be uselessly consumed in the case where the user cannot immediately find out the subject mobile unit 2. Also, an unauthorized third party different from the regular user will find out the subject mobile unit 2 and takes it away. For those reasons, it is preferable that the blowing from the buzzer 28 stops after the buzzer 28 has been blown for a predetermined period, for example, about ten seconds.

In the case of the mobile units 2 and 3 that execute the above processes as described above, the mobile units 2 and 3 can locate each other. Accordingly, differently from the exclusive mobile unit locating device that is used only for locating the mobile units 2 or 3, the plural mobile units 2 and 3 can be routinely used for the original intended purpose of the mobile units 2 and 3 (the intended purpose as the electronic key), respectively, and the operation chances can be increased more than that of the exclusive mobile unit locating device.

Also, even if all of the mobile units 2 and 3 are not routinely used, for example, one mobile unit 2 may be normally used as a main mobile unit, and another mobile unit 3 may be stored as an auxiliary mobile unit. In the case, as described above, when the mobile unit 2 is lost, the lost mobile unit 2 can be located by the auxiliary mobile unit 3. Conversely, even when the storage location of the auxiliary mobile unit 3 is forgotten, there is advantageous in that the auxiliary mobile unit 3 can be located by the mobile unit 2.

In addition, in the present embodiment, in order to realize the search between those mobile units 2 and 3, there is provided the UHF receiver unit 23 that uses the UHF band as a second frequency band in addition to the LF receiver unit 21 that uses the LF band as a first frequency band.

Accordingly, differently from the LF receiver unit 21 suitable in limiting the detection area of the mobile unit to the periphery of the vehicle, even if the output power level when transmitting the search signal from the UHF transmitter unit 22 is relatively low, the communication distance is comparatively ensured. As a result, the detection area of the mobile unit 2 or 3 can be enlarged.

That is, from the only viewpoint that the mobile units 2 and 3 communicate with each other, there can be proposed a method of providing the LF transmitter unit that can implement a communication with the LF receiver unit 21 instead of the provision of the UHF receiver unit 23. However, even if the LF transmitter unit of this type is provided in the mobile units 2 and 3, it is not easy to sufficiently increase the communication distance between the mobile units 2 and 3. When the output power level is increased or the receiver sensitivity is enhanced in order to increase the communication distance, the mobile units 2 and 3 will have to be upsized, or the power consumption will be increased. In this view point, as described above, when the UHF receiver unit 23 is merely disposed, the communication distance between the mobile units 2 and 3 can be sufficiently ensured without upsizing the mobile units 2 and 3 or increasing the power consumption.

In addition, the UHF transmitter unit 22 used in conducting a communication between the mobile units 2 and 3 is provided for conducting a communication with the in-vehicle device 1. For this reason, it is unnecessary to provide the exclusive transmitting means for realizing the communication between the mobile units 2 and 3.

Further, the search signal including a code that specifies the subject mobile unit 2 is transmitted from the auxiliary mobile unit 3 to the subject mobile unit 2. In the subject mobile unit 2, when the search signal includes the code that specifies the subject mobile unit 2, the fact that the subject mobile unit 2 exists is reported to the surrounding by the buzzer 28. Accordingly, even when third and fourth mobile units which are not at the locating side and the located side further exist in addition to the auxiliary mobile unit 3 and the subject mobile unit 2, only the subject mobile unit 2 informs its existence, thereby making it possible to prevent the unnecessary information operations by the third and fourth mobile units. Moreover, in the process of S101, since the subject mobile unit 2 to be located by the user is selected, even when there exist plural mobile units that can be to be located, the notifying operation can be executed by only one of the mobile units.

In addition, when the auxiliary mobile unit 3 could receive the response signal from the subject mobile unit 2, the auxiliary mobile unit 3 displays that the response has been received from the subject mobile unit 2 on the display unit 27. As a result, it is possible to notify the user whether the subject mobile unit 2 exists within the detection area or not, even under the circumstance where the subject mobile unit 2 exists at a place where the user cannot recognize the notifying operation (blowing of the buzzer 28) of the subject mobile unit 2.

Also, since the auxiliary mobile unit 3 conducts the notification by way of the display, it is possible to prevent the user from confusing from which mobile unit a sound is issued by issuing the sound from both of the mobile units 2 and 3.

### Second Embodiment

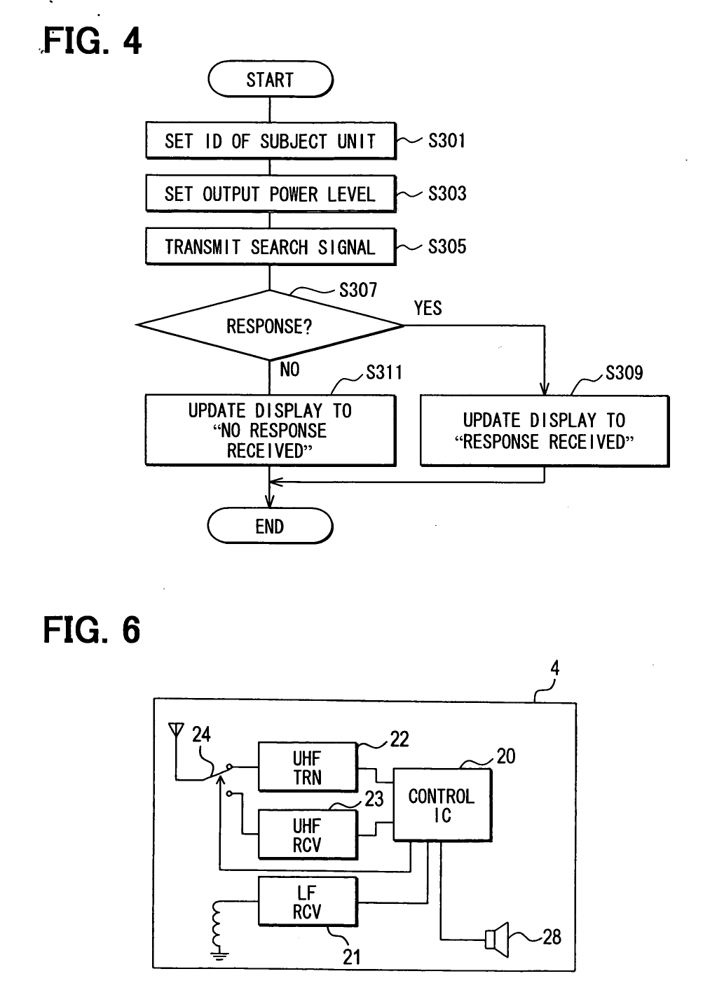

A second embodiment is similar to the first embodiment as shown in FIG. 4. In this embodiment, the locating function that is executed by the auxiliary mobile unit 3 that is the locating side is different from the first embodiment.

When the locating process starts, the auxiliary mobile unit 3 first sets an ID to be located (S301) in the similar manner as S101 in FIG. 2. Subsequently, the auxiliary mobile unit 3 sets the output power level (S303). In the process of S303, for example, when the user operates the push switches 25 and 26 in a given procedure, the operation mode of the auxiliary mobile unit 3 is changed over to the output power level setting mode. In the case of changing over to the output power level setting mode, when the user operates the push switches 25 and 26, the output level of the UHF transmitter unit 22 is changed over to 1, 2, 3, . . . in the stated order at multiple stages. How the present output power level is can be displayed on the LCD in the numerical or graphical display form as the occasion demands.

Subsequently, the auxiliary mobile unit 3 transmits the search signal including the ID to be located which has been set in the process of S301 (S305). In the process of S305, the search signal is transmitted at the output level that has been set in the process of S303 through the UHF transmitter unit 22.

The following process is identical with that of S105 to S109 described above, and the auxiliary mobile unit 3 checks whether a response is received from the subject mobile unit 2 or not (S307). When a response is received (Yes in S307), the display state of the display unit 27 is updated to “response received” (S309), and the locating process is completed. Also, when no response is received (No in S307), the display state of the display unit 27 is updated to “no response received” (S311), and the locating process is completed.

Even in the case of the auxiliary mobile unit 3, according to the second embodiment, the same operations and advantages as those in the first embodiment are provided, and the mobile units 2 and 3 can locate each other.

Moreover, in the auxiliary mobile unit 3, the transmission output power level can be changed by the manual operation through the process of the above S303. Therefore, for example, the subject mobile unit 2 may be first located only in respect of the near periphery of the auxiliary mobile unit 3. When the subject mobile unit 2 to be located is not located in such a near periphery, the detection area may be expanded. Thus, the range to be located can be expanded gradually by changing the output power level.

Also, in the case of the auxiliary mobile unit 3, even under the circumstance where the mobile unit 2 to be located exists at a place where the user cannot recognize the notifying operation due to the mobile unit 2 to be located, the place where the subject mobile unit 2 exists can be narrowed down to some degree to ease the locating effort.

More specifically, search is implemented at a first place by the aid of the auxiliary mobile unit 3. In this situation, the reception of a response from the subject mobile unit 2 will be displayed on the display unit 27 when the search area is relatively expanded. On the other hand, the reception of a response from the subject mobile unit 2 will not be displayed on the display unit 27 when the search area is relatively narrowed, In this case, the auxiliary mobile unit 3 is preferably moved in such a manner that even if the search area is relatively narrowed, a second place where a response is received from the subject mobile unit 2 on the display unit 27 is located.

When the above second place is found out, it is meant that the second place is closer to the subject mobile unit 2 than the first place. In the above manner, responses from the subject mobile unit 2 at several places are checked, thereby making it possible to narrow down the place close to the subject mobile unit 2 to some range.

Accordingly, when the subject mobile unit 2 is located in the vicinity of the center of the narrowed range, the subject mobile unit 2 is likely to be found out even under the circumstance where the subject mobile unit 2 exists at the place where the notifying operation using the subject mobile unit 2 cannot be recognized by the user.

### Third Embodiment

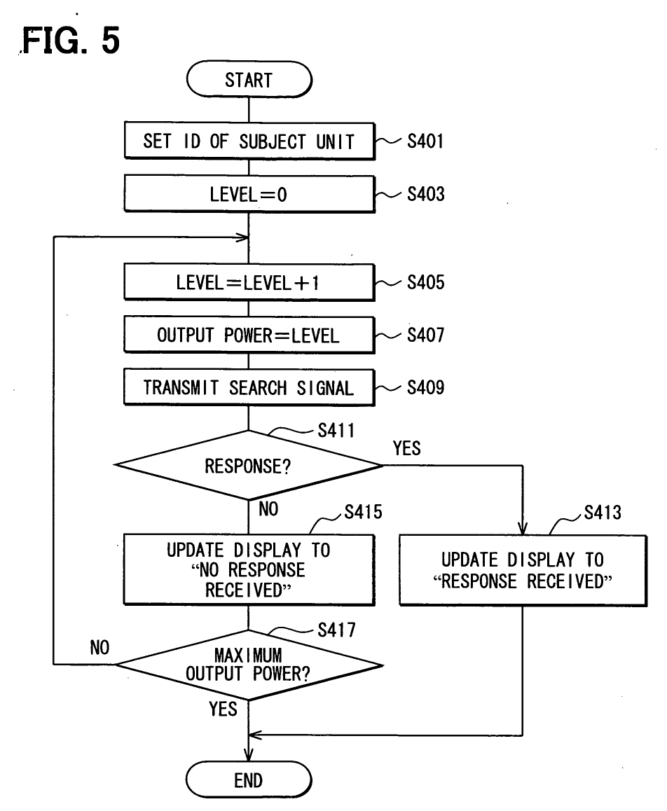

A third embodiment is similar to the second embodiment as shown in FIG. 5. In this embodiment, the locating function that is executed by the auxiliary mobile unit 3 that is the locating side is different from the second embodiment.

When the locating process starts, the auxiliary mobile unit 3 first sets an ID to be located (S401). This process is identical with that of S101. Subsequently, the auxiliary mobile unit 3 initializes a variable LEVEL indicative of an output power level of signal transmission to 0 (S403), increment the level by adding 1 to the previous variable LEVEL (S405), and sets the value of the variable LEVEL as the output power level (S407). That is, in the process of S303 described above, the user sets the output level by the manual operation, but in the process of S407, the value of the variable LEVEL is set as the output power level.

Then, the auxiliary mobile unit 3 transmits the search signal including the ID to be located which has been set in S401 (S409). In the process of S409, the search signal is transmitted at the output power level that has been set in the process of S407 through the UHF transmission unit 22.

Subsequently, the auxiliary mobile unit 3 checks whether the response is received from the subject mobile unit 2 or not (S411). When the response is received (Yes in S411), the display state of the display unit 27 is updated to “response received” (S413), and the locating process is completed. On the other hand, when no response is received (No in S411), the display state of the display unit 27 is updated to “no response received” (S415). It is determined whether the output level reaches the maximum output or not (S417).

When the output level does not reach the maximum output (No in S417), the processing is returned to the process of S405 to repeat the process of S405 to S415. As a result, in the process of S405, 1 is added to the variable LEVEL, and the value of the variable LEVEL is set as the output power level in the process of S407. That is, the output level is increased by one rank.

Then, as a result of repeating the process of S405 to 415, when it is determined that the output level reaches the maximum output in a process of S417 (No in S417), the search is given up at that time, and the locating process is completed.

According to the third embodiment, the same operations and advantages as those in the second embodiment are provided, and the mobile units 2 and 3 can locate each other.

Moreover, in the auxiliary mobile unit 3, the transmission output power level can be changed as with the auxiliary mobile unit 3 of the second embodiment. Moreover, unless the user purposely conducts the input operation in changing the detection area, the transmission output level is automatically and sequentially increased, and the detection area can be enlarged when the response signal from the subject mobile unit 2 cannot be received.

Further, the third embodiment shows an example in which the transmission output level is sequentially increased when the response signal from the subject mobile unit 2 cannot be received. Conversely, the transmission output power level may be sequentially decreased when the response signal from the subject mobile unit 2 can be received.

In this case, as has been described in the above second embodiment, the user moves to a certain place where the response is received while confirming the presence or absence of the response from the subject mobile unit 2, thereby making it possible to narrow down the place where the subject mobile unit 2 exists.

There can be applied only any one or both of a configuration in which the transmission output power level is sequentially increased when the response signal from the subject mobile unit 2 cannot be received, and a configuration in which the transmission output level is sequentially decreased when the response signal from the subject mobile unit 2 can be received.

The above embodiments may be modified in many ways as exemplified below.

In the above embodiments, the mobile units 2 and 3 can locate each other. However, when plural mobile units that constitute the electronic key system exist, some mobile units may be a simplified mobile unit that has no locating function provide in the mobile units 2 and 3. More specifically, as in a mobile unit 4 shown in FIG. 6, there are provided a control IC 20, an LF receiver unit 21, a UHF transmitter unit 22, a UHF receiver unit 23, a transmit/receive changeover switch 24, and a buzzer 28. This mobile unit 4 has no push switches 25, 26, and the display unit 27, which are provided in the mobile units 2 and 3. Also, software for executing the locating process is deleted from the control IC 20.

The mobile unit 4 structured as described above cannot be used as the locating mobile unit. Since the UHF receiver unit 23 and the buzzer 28 are provided, the same operations and advantages as those of the mobile units 2 and 3 are provided as the subject mobile unit to be located. Therefore, for example, in the case of assuming an intended purpose in which plural family members carry the mobile units, respectively, parents may carry the mobile units 2 and 3, and a child may carry a mobile unit 4. When the child loses the mobile unit 4, the parents locate the mobile unit 4 by the aid of the mobile units 2 and 3.

The mobile units 2 and 3 cannot be located by the mobile unit 4. However, since a case in which both mobile units 2 and 3 are lost at the same time is rare, it is sufficient that the mobile units 2 and 3 can locate each other. Rather, it is useful that the third mobile unit is configured as with the mobile unit 4 from the viewpoint that the costs required for introduction of the entire electronic key system can be suppressed. Also, when it is assumed that the child carries the mobile unit, a case in which the button operation cannot be unnecessarily conducted may be better. From this viewpoint, it is useful that the push switches 25 and 26 are omitted as with the above mobile unit 4.

It is possible that the mobile unit has only locating function as opposed to the mobile unit 4. The electronic key system in which the above mobile units are mixed together can be possible. If the mobile unit only has the locating function, it will not be located when lost.

A mobile unit locating device may be used in the electronic key system. More specifically, as the mobile unit locating device corresponding to the electronic key system of the above embodiment, there is provided a device having transmitting means that can transmit the search signal to the subject mobile unit 2 by the electric waves of the UHF band (the second frequency band). That is, there is provided not the mobile unit locating device that conducts the communication at the LF band, but the mobile unit locating device that conducts the communication at the UHF band. Thus, the mobile unit locating device can be adapted to the electronic key system of the above embodiments.

When the above mobile unit locating device is provided, the mobile units 2, 3 and 4 can be located. Since the exclusive mobile locating device cannot be used as the mobile unit of the electronic key system, when there is considered that the application chances are increased, the above mobile units 2 and 3 are better.

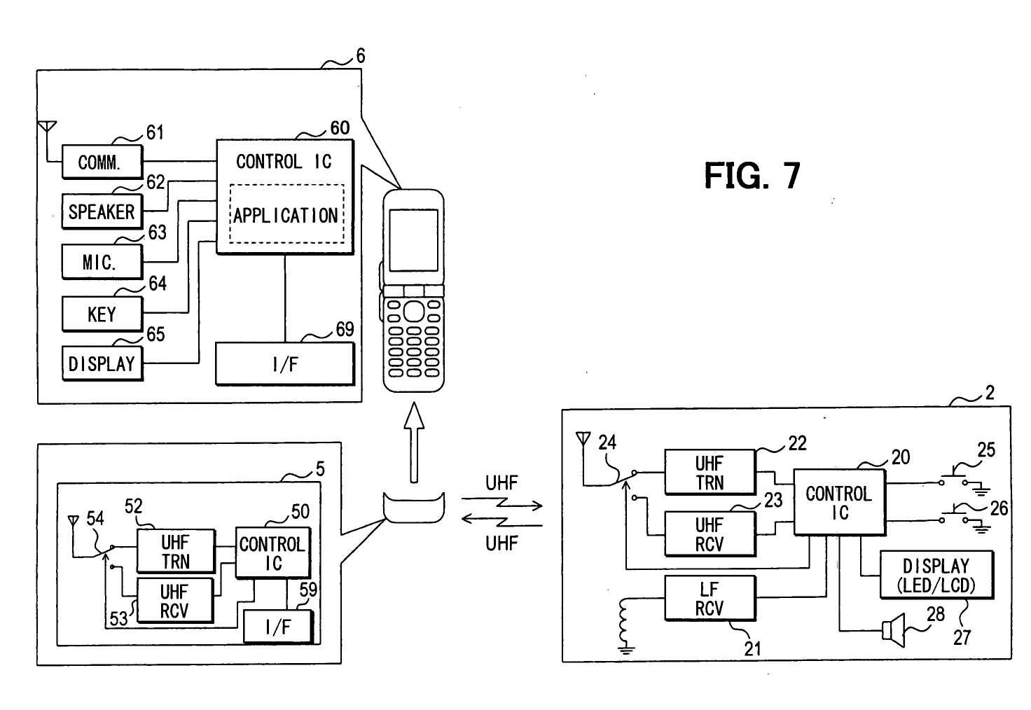

In addition, in the case of configuring an exclusive mobile unit locating device 5, as shown in FIG. 7, the locating unit 5 may be connected to a mobile phone 6, to thereby provide the exclusive mobile unit locating device.

The locating unit 5 has a control IC 50, a UHF transmitter unit 52, a UHF receiver unit 53, a transmit/receive changeover switch 54, and an interface circuit 59. Among them, the UHF transmitter unit 52, the UHF receiver unit 53, and the transmit/receive changeover switch 54 are identical in the configuration with those in the mobile units 2 and 3.

The mobile phone 6 has a control IC 60, a communication unit 61, a speaker 62, a microphone 63, an input key 64, a display unit 65, and an interface circuit 69. The mobile phone 6 is well known and structured so that the control IC 60 executes various processes according to an arbitrary application.

The locating unit 5 and the mobile phone 6 are connected to each other so as to communicate with each other through the interface circuits 59 and 69 provided in the respective locating unit 5 and the mobile phone 6. The control IC 60 controls the respective parts of the locating unit 5 according to the search unit control application, and executes the locating process.

The user interface required in execution of the locating process uses the configuration at the mobile phone 6 side. More specifically, the operation performed by the user at the time of locator is conducted by the operation through the input key 64 or by voice input through the microphone 63. The search results are output through the speaker 62 or the display unit 65 which is disposed at the mobile phone 6 side. That is, the configurations of the push switches 25, 26, the display unit 27, and the buzzer 28 which are disposed in the mobile units 2 and 3 have the configurations which are disposed in the mobile phone 6.

As is apparent from the above description, there is provided the mobile unit locating device that can be connected to the mobile phone 6 through the communication interface 59, and is configured so that mobile phone 6 controls the transmitting means 52 through the communication interface 59 according to the application program at the mobile phone 6 side so that the transmitting means 52 transmits the search signal. With the above configuration, the only minimum configurations that cannot be replaced with the configuration of the mobile phone 6 is mounted in the mobile unit locating device, and the remaining configurations can be structured by the mobile phone 6. Therefore, the configuration of the locating unit 5 is simplified as compared with the locating unit having the user interface, and the introduction costs of the locating unit 5 can be suppressed.

The communication interface between the locating unit 5 and the mobile phone 6 is not limited to the mechanical connection, but can be connected to each other by a radio communication interface. In this case, the locating unit 5 is, for example, of the key holder type, which can be equipped on the mobile phone or in the vicinity of the mobile phone.

The above embodiments may be implemented in an electronic key system for doors of other objects such as an office, a house and the like different from a vehicle.

What is claimed is:

1. A mobile unit for an electronic key system that includes an in-vehicle device for executing predetermined control, the mobile unit comprising:
first receiving means for receiving a radio signal that is transmitted from the in-vehicle device by an electric wave of a first frequency band;
transmitting means for transmitting a radio signal to the in-vehicle device by an electric wave of a second frequency band which is different from the first frequency band thereby to enable the in-vehicle device to conduct authentication required to execute the predetermined control;
second receiving means for receiving a radio signal including at least a search signal which is transmitted from another mobile unit by an electric wave of the second frequency band; and
notifying means for notifying outside existence thereof when the search signal is received by the second receiving means;
wherein the transmitting means is capable of transmitting the search signal in addition to the radio signal to the in-vehicle device.

2. The mobile unit according to claim 1, wherein the second frequency band is at a higher frequency side than the first frequency band.

3. The mobile unit according to claim 2, wherein the first frequency band is an LF band, and the second frequency band is a UHF band.

4. The mobile unit according to claim 1, wherein:
the transmitting means transmits a search signal including a code that specifies a further mobile unit; and
the notifying means notifies the outside of a fact that the further mobile unit exists when the search signal including the code that specifies the further mobile unit is received by the second receiving means.

5. The mobile unit according to claim 4, further comprising:
selecting means for selecting one of plural other mobile units in response to input operation of a user,
wherein the transmitting means transmits a search signal including a code that specifies the one of plural other mobile units that is selected by the selecting means.

6. The mobile unit according to claim 4,
wherein the transmitting means changes a transmission output power level to change an area of transmission of the radio signal thereof.

7. The mobile unit according to claim 6,
wherein the transmitting means changes the transmission output power level based on the input operation received from the user.

8. The mobile unit according to claim 6,
wherein the transmitting means changes the transmission output power level and transmits the search signal again when no response signal is received by the second receiving means after the search signal has been transmitted previously.

9. The mobile unit according to claim 1, further comprising:
display means for displaying that a response has been received by the second receiving means.

10. An electronic key system comprising:
an in-vehicle device mounted in a vehicle; and
a plurality of mobile units which conducts a radio communication with the in-vehicle device to enable the in-vehicle device to conduct authentication required to execute predetermined control by the in-vehicle device,
wherein at least two of the plurality of mobile units are mobile units according to claim 1.

11. An electronic key system for a door of an object comprising:
an in-object device provided in the object and having a receiving section for controlling the door in response to a predetermined signal of a predetermined frequency band received by the receiving section; and
a plurality of mobile units, each having a transmitter for transmitting the predetermined signal of the predetermined frequency band to be received by the in-object device,
wherein the transmitter is configured to transmit a search signal including an identification of a mobile unit, which is to be located, the search signal being of the predetermined frequency band, and
wherein the mobile unit has a receiver for receiving a search signal of the predetermined frequency band, and a notifying section for generating a notification indicative of existence of the mobile unit in response to a reception of the search signal by the receiver.

12. The electronic key system according to claim 11, wherein:
the in-object device further has a transmitting section for transmitting a signal of a predetermined frequency band, which is lower than the predetermined frequency band of the predetermined signal received by the receiving section;
the mobile unit has a receiver for receiving the signal transmitted from the transmitting section of the in-object device; and
the mobile unit further has a display for displaying that the search signal has been received by a mobile unit which corresponds to the identification included in the search signal.
